(19) United States
(12) Patent Application Publication
(10) Pub. No.: US 2009/0160696 A1
(43) Pub. Date: Jun. 25, 2009

(54) CONFIGURABLE RADAR DETECTION AND AVOIDANCE SYSTEM FOR WIRELESS OFDM TRANCEIVERS

(75) Inventors: Thomas E. PARE, Mountain View, CA (US); Chien-Cheng Tung, Fremont, CA (US); Kiran Uln, Pleasanton, CA (US)

Correspondence Address: SAWYER LAW GROUP LLP, 2465 E. Bayshore Road, Suite No. 406, PALO ALTO, CA, 94303, US

(73) Assignee: RALINK TECHNOLOGY CORPORATION, Cupertino, CA (US)

(21) Appl. No.: 11/963,658

(22) Filed: Dec. 21, 2007

(51) Int. Cl. G01S 7/42

(52) U.S. Cl. 342/20

(57) ABSTRACT

The present invention relates generally to wireless transceivers, and more particularly but not exclusively to radar detection and avoidance methodologies for wireless devices including transceivers. In one or more implementations, a method for detecting radar operating in the unlicensed 5.25-5.35 and 5.47-10.725 GHz radio bands, using wireless devices, such as WiFi AP, are provided. A WiFi AP is used to automatically detect the presence of radar on all channels in these bands, alert all of its clients, and move to another channel that is known to be devoid of radar using one or more implementations.

### FIELD OF THE INVENTION

The present invention relates generally to wireless transceivers, and more particularly but not exclusively to radar detection and avoidance methodologies for wireless devices including transceivers.

### BACKGROUND OF THE INVENTION

Providing the capability to detect the presence of radar in wireless devices during their operation in the unlicensed 5.25-5.35 and 5.47-5.725 GHz radio bands is required in various geographies of the world.

For instance, the European Union (EU) first harmonized the radio standard for unlicensed devices operating in the 5150-5350 MHz and 5470-5725 MHz frequency bands (standard EN 301 893 V1.2.3), which referenced dynamic frequency selection (DFS). The EU standard specifies the types of waveforms that systems operating in the 5250-5350 MHz and 5470-5725 MHz bands should detect and defines threshold and timing requirements. Thereafter, in the United States, the Federal Communication Commission issued Docket No. 03-287 which revised parts 2 and 15 of the FCC's Rules to Permit Unlicensed National Information Infrastructure (U-NII) devices in the 5 GHz band (Docket No. 03-122).

Under section 15.407(h)(2) (entitled: Radar Detection Function of Dynamic Frequency Selection (DFS)) of the US specification, U-NII devices operating in the unlicensed 5.25-5.35 GHz and 5.47-5.725 GHz radio bands (i.e., “unlicensed bands”) shall employ a DFS radar detection mechanism to detect the presence of radar systems and to avoid co-channel operation with radar systems. The minimum DFS detection threshold for devices with a maximum Effective Isotropic Radiated Power (EIRP) of 200 mW to 1 W is −64 dBm. For devices that operate with less than 200 mW EIRP, the minimum detection threshold is −62 dBm. The detection threshold is the received power averaged over 1 microsecond referenced to a 0 dBi antenna. The US standard further provides that the DFS process shall be required to provide a uniform spreading of the loading over all the available channels.

It will be understood by those skilled in the art that the Effective Isotropic Radiated Power (EIRP) is the apparent power transmitted towards the receiver, if it is assumed that the signal is radiated equally in all directions, such as a spherical wave emanating from a point source. It will be also appreciated by those skilled in the art that the use of terms “standard” and “specification” are to be used interchangeably and inclusively reference by incorporation standards and specifications associated expressly or impliedly with the subject matter herein. It will be further appreciated by those skilled in the art that the use of the term “radar” is intended to be RADAR as is widely understood to mean radio detection and ranging.

From such standards, it will be further appreciated that it requires that devices such as Wireless Fidelity (WiFi) Access Points (APs) are required to automatically detect the presence of radar on all channels in these identified unlicensed bands. Similarly, with the continued introduction of wireless local area networks such as Hiperlan/2 and IEEE 802.11 networks, the number of orthogonal frequency division multiplexing (OFDM) transceivers have increased dramatically, requiring compliance with the specifications.

Several international radar detection specifications (e.g., FCC 06-96, EN 301-893, etc.) further include both periodic (i.e., short pulse) and non-periodic (i.e., long pulse) waveforms that are required to be detected to be compliant with these specifications. In addition, these waveforms must often be detected in conditions that may be challenging for traditional detection systems, such as conditions having high data traffic.

Additionally, the new Dynamic Frequency Selection rule (DFS2), adopted in 2007, is further being required by the FCC to permit the co-existence of wireless local area network (WLAN) systems with existing military and weather radar systems in the 5 GHz band. Under the DFS2 ruling, the FCC requires that WLAN systems operating in the UNII-2 and UNII-3 bands must comply with DFS2 to prevent WLAN communications from interfering with incumbent military and weather radar systems. Under the DFS2 ruling, WLAN systems must now also continuously monitor the selected frequency channel during use and if radar signal is detected on that particular channel, the WLAN system must stop communications and switch to another available channel that is devoid of radar presence. This requirement is yet a further challenge for traditional systems.

Further complicating the situation and further limiting traditional systems are that radar signals have differing repetition rates, pulse widths, and burst lengths. In addition, WLAN systems must now be able to detect new patterns that are not periodic, but rather are sent at random intervals; must also be detected. Given this wide variety of patterns, traditional detection using a single module is burdensome and inaccurate, in part as the pattern parameters cannot be tuned for a specific waveform. As indicated previously, with the proliferation of WLAN applications, the above situations in combination with the realistic scenario that radar detection occurs at times when there is heavy WLAN data traffic, clearly exists. In this scenario, using traditional methods, detection may not be possible as the radar might be obscured by the orthogonal frequency division multiplexing (OFDM) signal. Unfortunately, traditional methods do not enable various filtering schemes options or the coordination between the packet processor and the radar modules for detection.

Therefore, it is highly desired to be able to provide a solution which overcomes the shortcomings and limitations of the present art and more particularly provides a configurable radar detection and avoidance method and system for wireless devices, including OFDM transceivers.

The present invention in accordance with its various implementations herein, addresses such needs.

### SUMMARY OF THE INVENTION

In various implementations of the present invention, a configurable radar detection and avoidance system is provided for wireless devices, including orthogonal frequency division multiplexing (OFDM) transceivers, thereby providing improved radar detection, timely transfers of communications to another channel as needed, and compliance with associated standards and specifications.

The present invention in various implementations provides for a configurable radar detection and avoidance system for wireless devices operating in the unlicensed band range.

In one aspect, one or more wireless devices, such as a WiFi AP, is used to automatically detect the presence of radar on each operable channel within the unlicensed band range, alert the clients in communication with the wireless device, and transfer the operation to another channel that is known to be devoid of radar.

In another aspect, a configurable radar detection system comprising: one or more radar detector modules each module capable of detecting radar signals of radar types different from one another, a detection and analysis module to determine radar presence from one or more detected radar signals of one or more radar detector modules, an automatic gain controller for controlling one or more detection parameters of one or more radar detector modules, and, a report signal for reporting detected radar signals, is provided.

In other aspects, using one or more wireless devices, a configurable radar detection and avoidance system is provided for detecting periodic (short pulse) and non-periodic (long pulse) waveforms. In further aspects, a configurable radar detection and avoidance system is provided operable in high data traffic situations.

In another implementation, the present invention is a data system having computer-readable program code portions stored therein to.

### BRIEF DESCRIPTION OF THE DRAWINGS

FIG. 1 depicts a diagram of a wireless local area network (WLAN) network having a radar detection and avoidance system, in accordance with one or more implementations;

FIG. 2 depicts a diagram of the AP baseband (BB) and medium access layer (MAC) processing associated with radar detection, in accordance with one or implementations;

FIG. 3 depicts a radar signal at the output of the baseband radar filter block, in accordance with one or more implementations;

FIG. 4 depicts the radar architecture to detect various types of radar signatures, in accordance with one or more implementations;

FIG. 5 depicts a flow diagram for periodic radar detection, in accordance with one or more implementations;

FIG. 6 depicts a flow diagram for pulse width radar detection, in accordance with one or more implementations;

FIG. 7 depicts a configurable filter structure for differing radar types, in accordance with one or more implementations;

FIG. 8 depicts radar detection of individual pulses which are uniquely determined by a width and time of arrival, in accordance with one or more implementations;

FIG. 9 depicts a typical received set of events for periodic radar types, in accordance with one or more implementations;

FIG. 10 depicts a valid set of 4 events of a periodic radar, in accordance with one or more implementations;

FIG. 11 depicts a scenario where the noise event is eliminated due to a period mismatch, in accordance with one or more implementations;

FIG. 12 depicts an example of FIG. 11 allowing for 1 noise event for every 4 true events in which there are 5 groups to be checked, in accordance with one or more implementations;

FIG. 13 depicts a periodicity validator for staggered radar type, in accordance with one or more implementations; and,

FIGS. 14a, 14b and 14c depicts various FCC-Type5 radar which has groups of pulses that are repeated at random, have no relative width requirement or have pulses where relative width is validated for one pair only, respectively, in accordance with one or more implementations.

### DETAILED DESCRIPTION

The present invention relates generally to a system for radar detection and avoidance methodologies for wireless devices including transceivers.

The following description is presented to enable one of ordinary skill in the art to make and use the invention and is provided in the context of a patent application and its requirements. Various modifications to the preferred embodiments and the generic principles and features described herein will be readily apparent to those skilled in the art. Thus, the present invention is not intended to be limited to the embodiments shown, but is to be accorded the widest scope consistent with the principles and features described herein.

As used herein, as will be appreciated, the invention and its agents, in one or more implementations, separately or jointly, may comprise any of software, firmware, program code, program products, custom coding, machine instructions, scripts, configuration, and applications with existing software, applications and data systems, and the like, without limitation.

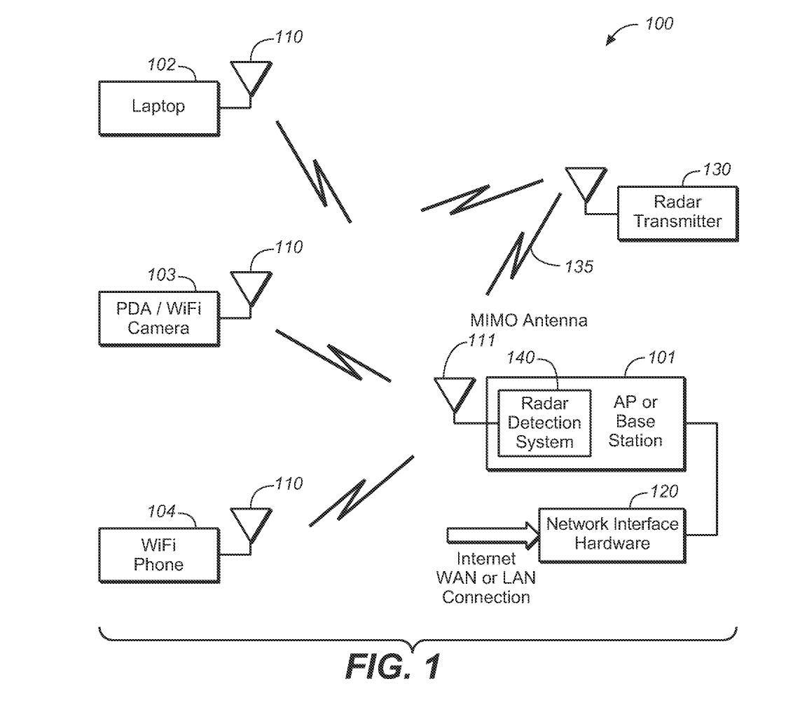

FIG. 1 depicts a diagram of a wireless local area network (WLAN) network having a radar detection and avoidance system in accordance with one or more implementations.

In FIG. 1, a WLAN system 100 is depicted with components (i.e., client devices, devices or clients) of the WLAN that are in communication or capable of communication with the AP 101 and one another, as each is comprised of communication capability 110 and technology associated with WiFi-equipped devices 111, for example. Client devices, such as a laptop computer 102, a personal digital assistant (PDA) 103, or a WiFi (Skype) phone 104, are examples of clients, but the present invention and its associated implementations are not so limited. By further example the AP, or base station, 101 is also in communication with a internet WAN or local area network (LAN) at 120.

From FIG. 1, each device is capable of wireless transmission back to the base station, or AP, using a standard communication protocol and modulation scheme, such as but not limited to IEEE802.11a. Examples of types of applications and services supported by this type of network include Internet browsing on a laptop, photo sharing with a network enabled camera, phone call conversations via a “WiFi” phone, video viewing or sourcing with a high definition television (HDTV) or video server, or audio streaming of internet radio programs.

In FIG. 1, the AP, while communicating with the clients, is also capable of detecting a RADAR source 130 on the communication channel via the radar detection system of the present invention 140, in one or more implementations. If a transmitted DFS radar signal 135 is detected by the AP via the radar detection system 140, the AP will announce the presence of the radar detection by notifying the clients of a channel change, ceasing communication and changing all clients to a new channel that is known to be devoid of radar.

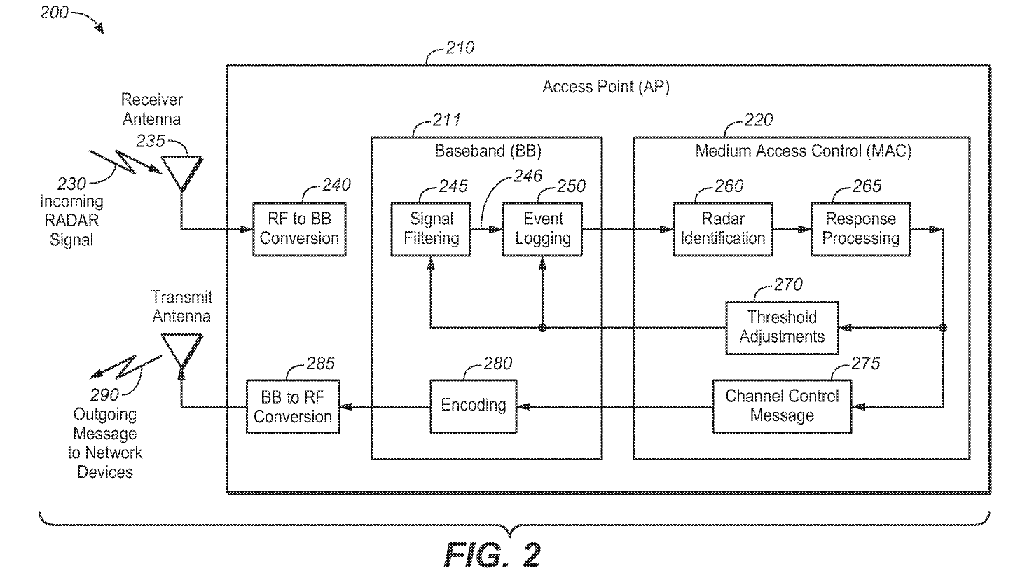

FIG. 2 depicts a diagram 200 of the AP baseband (BB) 211 and medium access layer (MAC) processing 220 associated with radar detection, in accordance with one or more implementations.

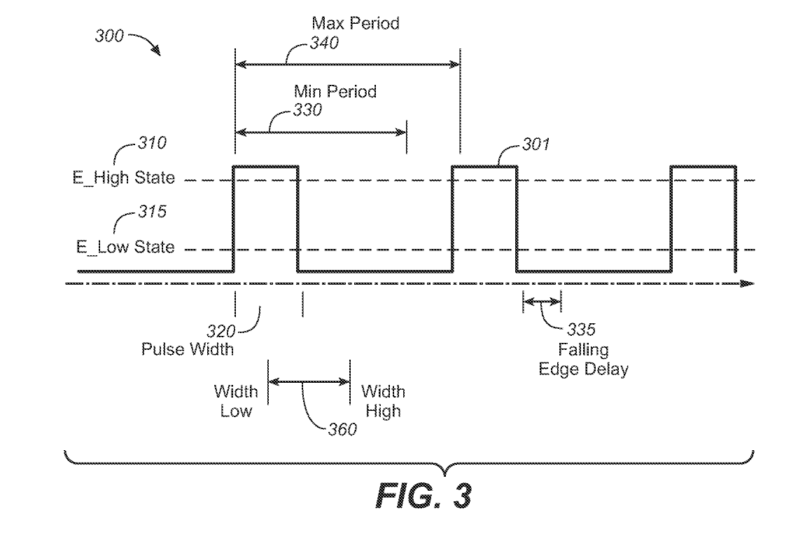

From FIG. 2, the AP 210 is equipped with the radar detection and avoidance system of the present invention, in one or more implementations. After the radar signal 230 enters (or is detected by) the receiver antenna 235, the detected signal is converted to baseband by a converter 240, and thereafter filtered to remove noise and any other non-radar signal energy by a signal filter 245. A radar signal is output from the baseband radar filter block at 246, and is further referenced in FIG. 3. Radar waveforms are detected by measuring periodicity, pulse width, chirp rate, and other signal features, and these “events” are logged in the baseband by the event logger 250 for future pattern recognition processing. It will be appreciated by those skilled in the art that the event logger retains event data which enhances the detection reliability and therefore will also lower false-alarm rates for the present invention. Preferably, the event logger also has preset thresholds for periodicity and number of logged events. Upon the event logger reaching predetermined or preset thresholds for periodicity and number of events, these logged events (i.e., event results) are passed from the baseband 210 to the medium access layer 220. Preferably the MAC layer 220 is software-based and operates at a rate having a lower update requirement.

The logged events that are passed to the MAC along 255 are checked against known radar patterns, and optionally for self-consistency (e.g., persistence of a certain type of radar), at the radar identification block 260. Optionally, the MAC response processing 265 modifies the baseband radar thresholds via the threshold adjustment block 270 in order to improve reliability of the radar detection. In an alternate implementation, instead of adjusting the threshold via 270, the MAC may declare the presence of a valid radar and initiate the appropriate response. Thereafter, a channel control message (CCM) is prepared at 275 to be sent to the network clients. The CCM is optionally encoded at 280, converted to radio frequency at 285, and via the transmission from the AP at 290, in which the CCM contains information requesting all associated clients to change to an operating channel clear of radar signals, as designated. It will be understood by those skilled in the art that “associated client(s)” includes those clients and devices in or capable of communication with the AP.

FIG. 3 depicts a radar signal 300 at the output of the baseband radar filter block (as depicted in FIG. 2 at 246), in accordance with one or more implementations.

From FIG. 3, when the radar signal 301 crosses the E_HIGH_STATE threshold along 310, the HIGH state processing is initiated. During this period of HIGH state processing, the period count commences. The period count continues until the next HIGH state threshold crossing occurs. As depicted in FIG. 3, an E_LOW_STATE threshold is set forth at 315.

Also from FIG. 3, additionally the pulse width count is started at 320, and continues until the radar signal falling edge at 335 is detected and the LOW state is activated. The period and width measurements are recorded in the event logger (i.e., event log), as previously discussed.

Further from FIG. 3, preferably, for substantive radar pattern qualifications, a measured period would be within the range of a MIN period length at 330 and a MAX period length at 340. Similarly, preferably, for substantive radar pattern qualifications, the pulse width would also be within the range of a width low and width high range at 360.

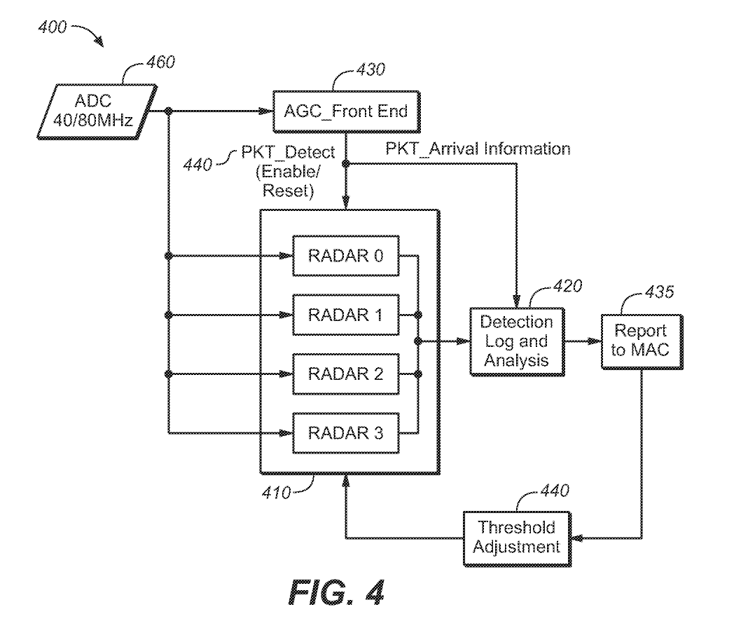

FIG. 4 depicts the radar architecture 400 to detect various types of radar signatures, in accordance with one or more implementations;

From FIG. 4, the radar architecture 400, suitable for a system implementation, comprises a bank of detector modules 410 (e.g., 0-3, four shown) that can be individually tuned to handle either periodic or long-pulse radar types. The system architecture also provides for a Detection Log and Analysis module 420, an automatic gain control (AGC) state indication 430, the AGC Packet Detection function 440, a MAC reporting block 435, a threshold adjustment option at 450 and an analog to digital converter 460.

The Detection Log and Analysis module 420 records possible radar pulse events and uses pattern recognition algorithms to determine the presence of radar with a high degree of probability, and a low false detection rate. The AGC state indication 420 enables/resets various elements of the radar module. The AGC Packet Detection function 440 also serves to qualify/disqualify radar detection events in the Detection Log 420, where possible false radar “hits” are removed if energy bursts associated with data packets are determined.

From FIG. 4, the MAC reporting block 435 provides a report signal to the MAC layer for additional radar detection decisions/screening. At the MAC layer various measures to increase the reliability of radar detection are performed. These may include controlling the loading of network data loading to ensure good observation periods, and increasing the thresholds in the various modules to either increase or decrease the radar detection system sensitivity to a particular radar pattern.

In FIG. 4, the radar detector modules 410 are programmable to detect either long-pulse or periodic types of radar. These two radar modes are functionally similar in structure, with each assessing for rising and falling energy conditions, and computing periodicity or pulse widths when the energy exceeds a certain threshold.

For event logging and analysis, the detected energy pulses are sent from the detector modules 410. All of the occurrences of detected energy pulses are logged at 420 to determine the most likely radar pattern present. This is done by logging the time of arrival of the pulses, and any other associated radar parameter, such as pulse width or chirp rate. The periodicity will be determined by back-differencing the time-of-arrival values. To allow for missed radar pulses, both the fundamental radar period and integer multiples of the fundamental will be counted. When multiple occurrences of a particular period (or pulse width for long-pulse) are detected, the radar information will be passed to the MAC layer at 435. The MAC layer will then preferably respond with the proper radar avoidance operations.

For MAC detection, the MAC responsibility in radar detection is to maintain proper adjustment of the detection parameters. The MAC, for example, can respond to too many false-detections by raising energy thresholds for a particular detector module. Similarly, if a certain radar is found to be present consistently, more than one detector module can be optimized for this particular pattern, to cover a wide range of radar signal strengths.

For AGC/Radar Detection interaction, operationally, radar pulses (particularly short pulses like FCC Type 1) can be mistaken for the beginning of an OFDM packet. In order to reduce the sensitivity of radar detection to OFDM packet arrivals the Detection Log 420 is to be cleared of any radar hits that occur during the period when an OFDM packet is detected. Similarly, in severe cases such as strong OFDM compared to relatively weak radar signals, the radar detector modules may be disabled (e.g., temporarily increasing energy thresholds) during the reception of OFDM packets. Radar detection is resumed after the packet has been fully processed.

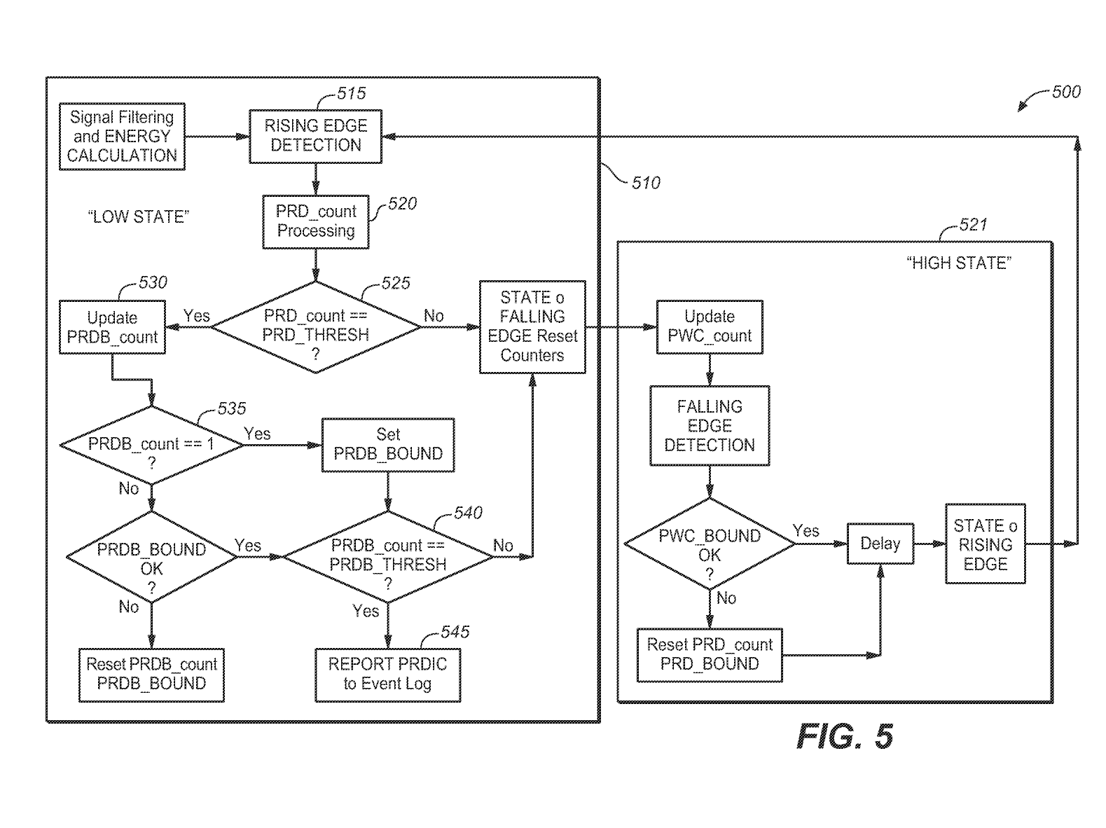

FIG. 5 depicts a flow diagram 500 for periodic radar detection, in accordance with one or more implementations.

From FIG. 5, in periodic detection mode, the radar module (i.e., modules within the bank 410 of FIG. 4) uses a filtered version of the ADC data to toggle between a LOW state 510 and a HIGH state 521, for the periodic detection module. In general, after filtering, the rising edge of the energy signal may be detected using an appropriate threshold setting. The period count is then determined with respect to the previous rising edge, to provide an estimate of the period of the received signal. The measured period is compared to previously measured periods to determine if the presence of a persistent radar pattern is present. If the number of repeating periods exceeds a threshold count, this event is stored as a possible detected radar pattern.

From FIG. 5, after filtering the received data and initialized to the LOW state 510, a rising edge is detected at 515 when the energy exceeds a rising-edge threshold. This event is preferably stored and, if a previous rising edge had been detected, the period or time between pulses is also recorded. If this period has been measured before, to within a programmable percentage, then the periodic count PRD_count is incremented at 520, or else reset to 1 (i.e., to look for the repeat occurrence of the new period) at 520.

If the PRD_count reaches a preset PRD_THRESH at 525, the counter PRDB_count is incremented at 530. This indicates the presence of a certain periodic signal. The measured period is then stored and associated with the respective “batch” of pulses. If the period has been measured previously to within a preset percentage for a previous “batch” of pulses, a batch count is incremented. If the measured period is outside of the preset threshold, then the PRDB_count is reset to “1” at 535, which indicates the possible presence of a new radar waveform. When the PRDB count reaches the threshold PRDB THRESH at 540, then this event is then sent to the Event Logger for further detection analysis at 545.

After any rising edge has been detected the Periodic detector module then enters the HIGH state 521. During this mode, the width of the energy pulse is measured to see if it is consistent with any of the set of known radar pulse widths. If it is not, the PRD_count is reset to “1”, which essentially disqualifies that particular pulse. If it is, the measured pulse width PWC_count is within the known set of pulse widths, such that its value is stored. Subsequent measured pulse widths in the batch are then compared to the first PWC_count to see if there is a repeating pattern. If any pulse width is out of bounds, the PRD_count is set to one, and this new PWC becomes the reference for subsequent PWC checking.

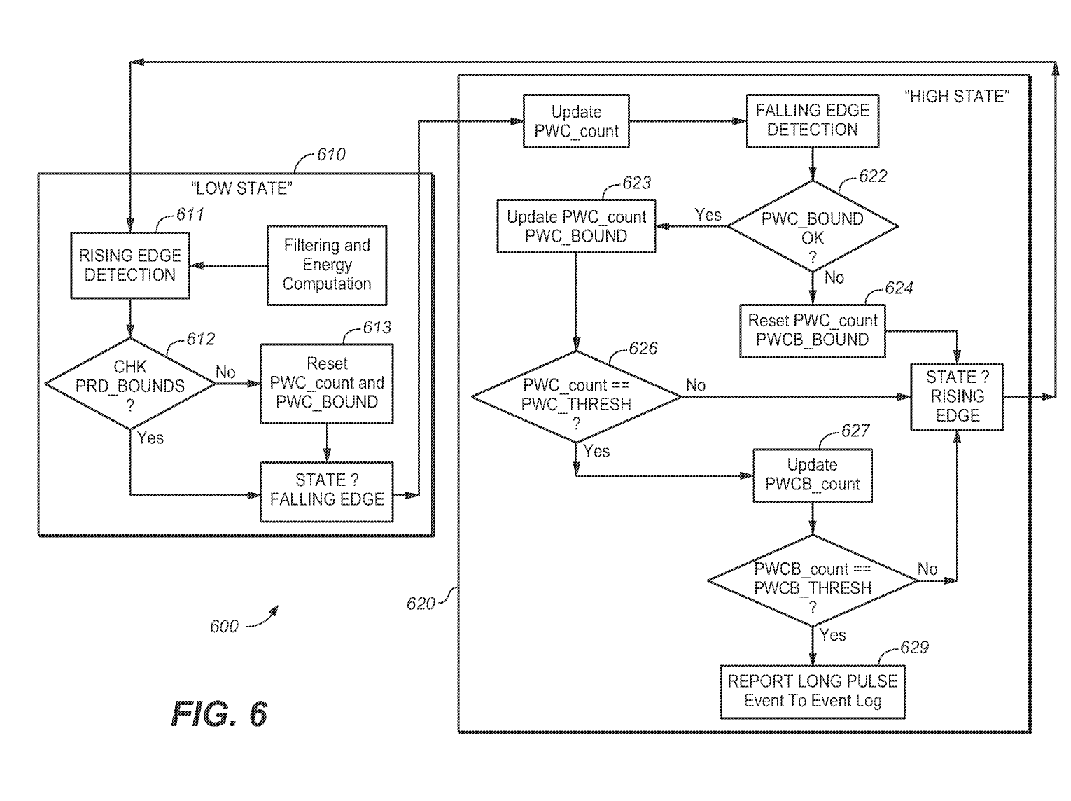

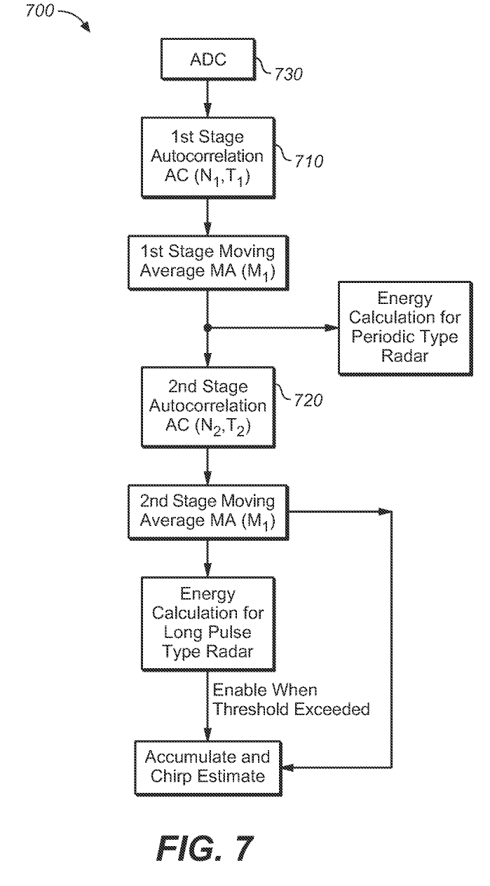

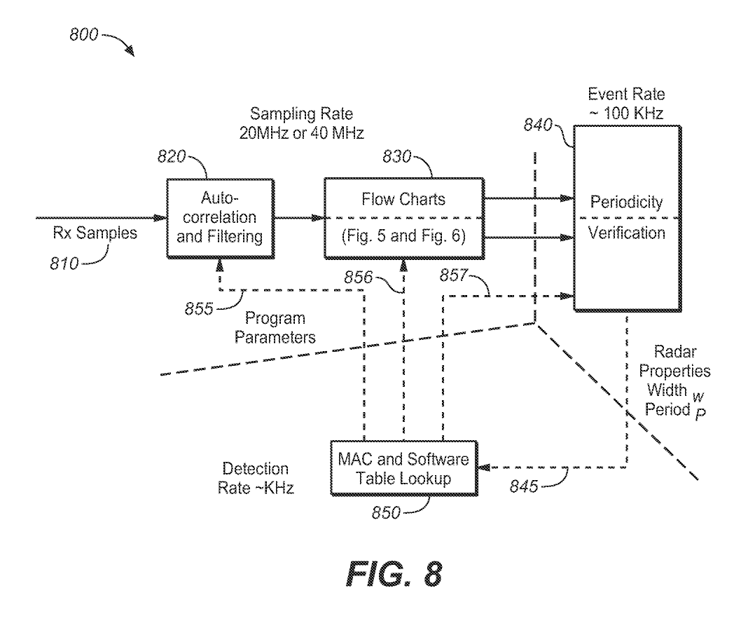

FIG. 6 depicts a flow diagram 600 for pulse width radar detection, in accordance with one or more implementations.

FIG. 6 sets forth a Long-Pulse detector module having a similar structure as that of the Periodic detector of FIG. 5, with alternating LOW state 610 and HIGH state 620. It is widely understood that Long pulse radar, and as specified by the FCC, are not periodic, but rather have bursts that occur within a specified time period (1 msec to 2 msec), and are characterized by a longer pulse (50 to 100 microseconds) than the periodic type (typically less than 20 microseconds). Long pulse bursts may contain 1, 2 or 3 pulses, and each pulse in the burst must have the same width, and accordingly, chirp rate.

Operationally, in accordance with one or more implementations, when the Long Pulse detector measures an energy pulse, its width is checked to see if it meets the FCC width bounds at 622. If the FCC width bounds are met, the PWC_count is incremented at 623. If the PWC_count is below the PWC_threshold, subsequent PWC_counts are compared to the initial PWC_count at to see if there is a repeating radar pattern at 624. If the subsequent PWC is within a certain percentage bounds, then PWC_count is incremented. If PWC_count reaches the PWC THRESH at 626, the PWCB count is incremented at 627, and the PWC count is reset to zero, detection for a new burst begins. When PWCB_count reaches the preset PWCB_THRESH, the potential Long Pulse event is recorded in the event logger at 629.

In addition to PWC range checking, as described above, the time period between pulses in a burst is computed and compared to the spacing allowed by the FCC in accordance with one or more implementations. As shown in FIG. 6, in the LOW state, after a Rising Edge detection at 611, if the PRD count is not within the PRD bounds at 612, the PWC count is reset to zero at 613 and PWC bound reset to the initial values (ie, corresponding to the full FCC range 50 -100 microseconds).

Still, in one or more implementations, a further parameter can utilize the chirp rate, in addition to the pulse width. Advantageously, this additional parameter utilization further reduces the possibility of false detection, since the chirp rate must be within prescribed FCC bounds, and must be the same for all long radar pulses within the burst. FIG. 7 sets forth filtering detail for measuring the additional parameter.

FIG. 7 depicts a configurable filter structure 700 for differing radar types, in accordance with one or more implementations. FIG. 7 presents a configurable filter structure to generate the energy signals that are the inputs to the parameter detection modules of FIGS. 5 and FIG. 6.

It is understood that the FCC requires radar detection for DFS to occur during periods of AP/Client transceiver operation. Operationally, therefore, the AP must detect radar while data packets are being received from the client. During this operation, the radar and OFDM packet may overlap from time to time, and the OFDM energy may be as strong as the radar pulse. A result of this overlap situation is that a 0 dB detection problem arises, where the OFDM is an equal strength noise source.

This result is problematic for traditional methods of detection, partly due to the 0 dB issue and partly as the situation is further complicated as the radar signatures may vary greatly. Thus, it will be appreciated by those skilled in the art that a single filter module is unable to accurately account for all radar types by providing allow optimal detection performance.

In FIG. 7, a two-stage autocorrelation filter 700 structure is depicted wherein the first stage is at 710 and the second stage is at 720. The autocorrelation filter, though sequentially set forth in FIG. 7, is referentially given as:

$$y ( k ) = {\sum }_{j = 0}^{N} x ( k - j ) x * ( k - j - T ) ,$$

where x(k) is the input 730, and y(k) is the output.

The modules are configurable and/or programmable by adjusting the parameter N, which is the length of the autocorrelation average, T, which is the delay, or lag parameter. By adjusting these parameters jointly, the filter can be optimized to respond to radar of different length.

The second stage of the autocorrelation structure 720 is designed specifically for the long-pulse radar type (FCC type 5). This second autocorrelation stage optimizes the response to type 5 radar by removing the chirp, or time-varying frequency modulation, of the radar signal prior to energy calculation.

Referring to FIG. 4, the bank of detector modules, shown in FIG. 1, will contain filters programmed for a specific radar pattern. For example, a filter module intended to detect periodic, non-chirped radar with pulse widths of 2 microseconds (FCC Type 2) will have the second autocorrelation disabled, and the I autocorrelation parameters N1 and T1 programmed to respond to pulses with a 2 microsecond duration.

FIG. 8 depicts radar detection 800 of individual pulses which are uniquely determined by a width and time of arrival, in accordance with one or more implementations. From FIG. 8, an arrangement of earlier described figures and processes is procedurally set forth. At 810 the radar data is received and auto-correlation and filtering, as previously described, is undertaken at 820. The output of the auto-correlation and filtering is input as one of the inputs for the radar detection process of a periodic or pulse width scheme at 830 (as in FIGS. 5 and 6 respectively). The output of the periodic or pulse width radar detection schemes is then verified and also assessed for periodicity at 840. The information obtained in 830 is provided and recorded at 845 to the MAC layer at 850, and prior data is available from the MAC layer for use in the respective process of auto correlation 820, radar detection 830 and/or periodicity/verification 840, along 855, 856 and 857 respectively, as previously described.

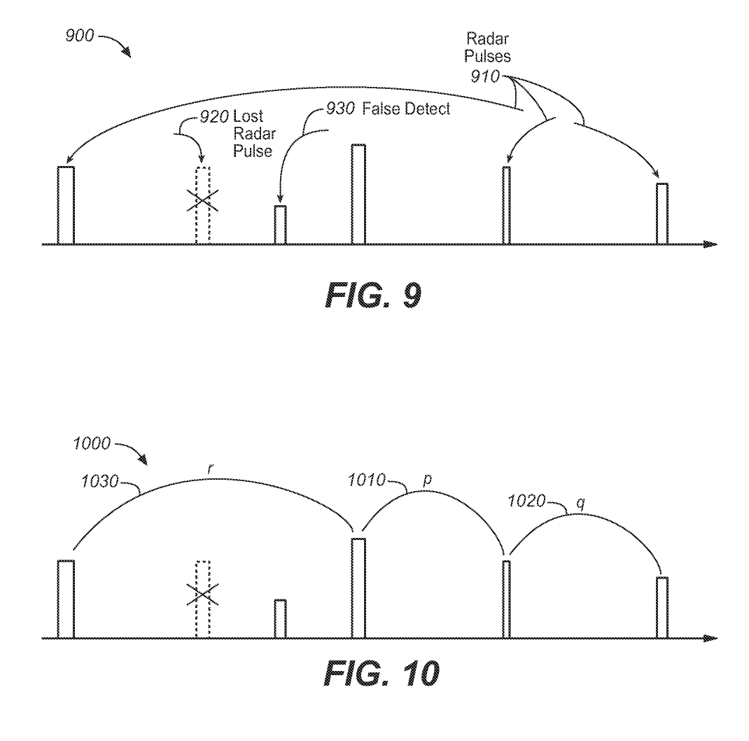

FIG. 9 depicts a typical received set of events for periodic radar types, in accordance with one or more implementations;

From FIG. 9, the detected radar pulses are depicted at 910. It will be appreciated by those skilled in the art that the widths of each event are a noisy measurement of the transmitted width. The broken event 920 is the lost radar pulse and the pulse at 930 is a spurious event due to noise. The ability to distinguish the spurious event from the observed events is a particular challenge which traditional methods are also limited by.

However, using the one or more implementation herein, and referencing FIG. 10 which depicts a valid subset of 4 events out of a total of 5 detected events of a periodic radar 1000, in accordance with one or more implementations, the following process sets forth a method of validating the observed pattern against a template.

1. Choose M (4) events that result in M-1 (3) time differences (periods)

2. Let p denote the minimum period (see 1010)

a. Verify that p is a valid radar period (see 1010)

3. for all other time differences (q and r), (see 1020 and 1030, respectively)

a. Check that time differences are multiples of p (within measurement errors)

b. Check the relative widths within measurement errors of the width w of p

4. If all the conditions are satisfied, then, the set of M events is said to be valid with period p and width w.

The parameters p and w are reported to the MAC or software which can verify that these match the pattern of the radar. Advantageously, the process, in one or more implementations has the flexibility to allow multiple pulses to be missed by requiring that q and r are only multiples of p.

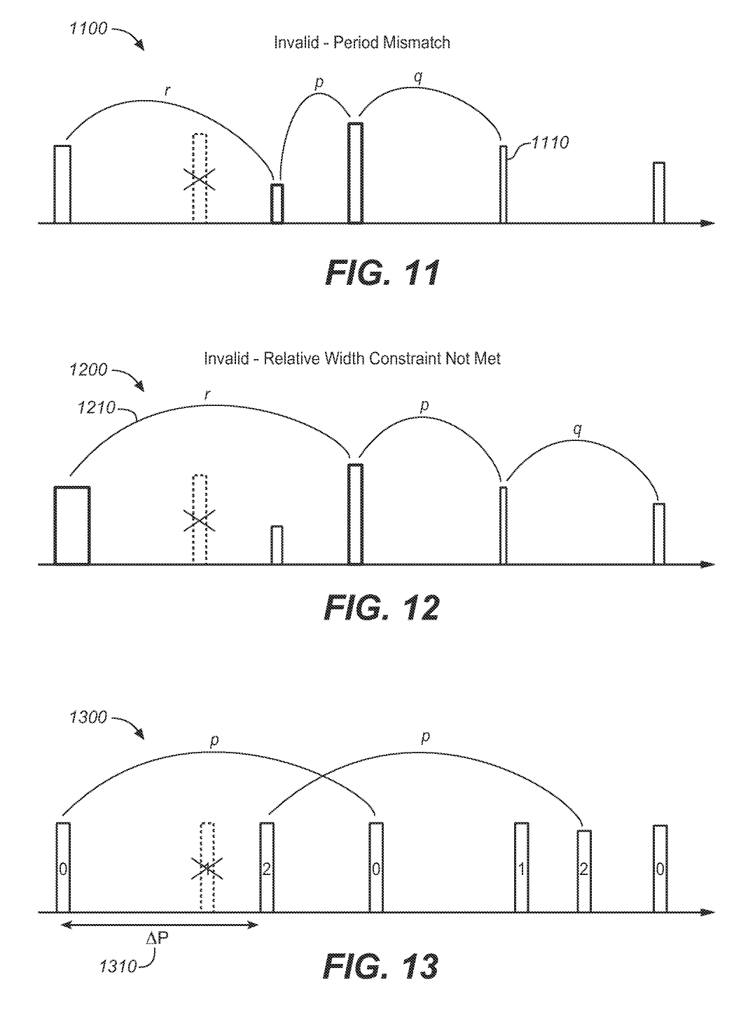

A further aspect of one or more implementations, further eliminates for spurious/false events during the periodicity check. FIG. 11 depicts a scenario 1100 where the noise event is eliminated due to a period mismatch, in accordance with one or more implementations. From FIG. 11, it will be appreciated that the subset of 4 events shown selected will cause conditions 2 and 3a above to be violated resulting in a mismatch at 1110.

A further aspect of one or more implementations, further discounts for observations made in noisy environments. FIG. 12 depicts an example 1200 of FIG. 11 allowing for 1 noise event for every 4 true events in which there are 5 groups to be checked, in accordance with one or more implementations. From FIG. 12, a noisy measurement affects the width of the first pulse 1210 which meets all constraints except 3b from the above process. The periodicity check of one or more implementations eliminates this set of events. In FIG. 12, the example shown maintained the previous N(5) events and verified M(4) pulses. This allows for 1 noise event for every 4 true events and there are 5 such groups to be checked.

A further advantage of the above process, in one or more implementations, is that the process may be used to identify other types of radar sequences also. FIG. 13 depicts a periodicity validator 1300 for staggered radar type, in accordance with one or more implementations. In staggered radar, there are multiple periodic pulses (0, 1, 2 in the figure) which are placed at relative offset to one another at 1310. The periodicity check isolates 2 pairs of events and

1. Verifies that events in both the pairs match the width requirement

2. Verifies that the 2 time differences p are (within measurement errors) valid

If both conditions are satisfied, the module returns the primary period p, the width w and the relative offset AP to the MAC or software for further validation. This method of validation provides extra flexibility to the hardware, while using MAC/software interaction.

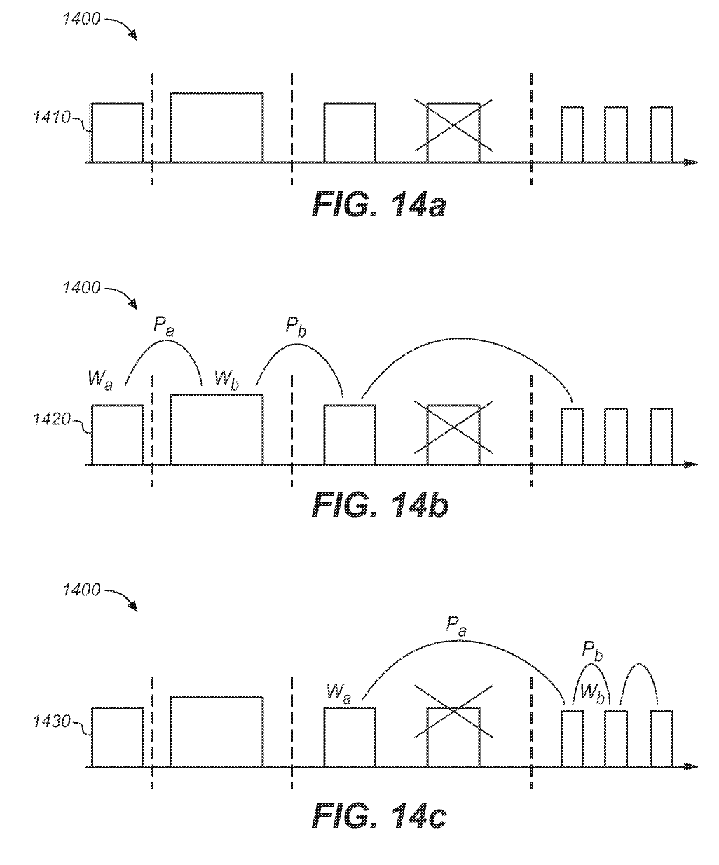

Similar concepts in one or more implementations can be utilized to detect FCC-Type5 radar, which has very minimal periodic nature. FIG. 14a shows a typical FCC-Type5 radar 1410 which has groups of pulses that are repeated at random. FIG. 14b identifies the pulses which have no relative width requirement (condition 3a is removed) 1420 and FIG. 14c identifies pulses where relative width is validated for one pair only 1430. The actual implementation will depend on robustness and SNR of operation. In this type of radar, the MAC/software will receive periods pₐ, p_{b} and the widths wₐ, w_{b} for further validation.

One of the numerous advantages over the prior methods is that in one or more implementations, radar detection is able to run in parallel with normal packet processing. The advantage is that high data throughput can be maintained while the AP actively seeks to detect the presence of radar. Also, by filtering for specific radar patterns, the signal-to-noise ratio of the radar signal can be improved, particularly during OFDM operation. This enhances the detection rate, and lowers the probability of false alarms.

A further advantage in one or more implementations is that the back-difference buffer also enables the detection to occur reliably during OFDM operation by logging radar events between OFDM packets. By logging the radar pulse times and durations, the radar timeline can effectively be reconstructed and compared to known radar patterns. This enhances the reliability of detection compared to looking for a single set of contiguous radar pulse, by allowing for the radar pulse train to be interrupted by noise or OFDM packets.

As used herein, the term OFDM transceivers are widely used in wireless applications including ETSI DVB-T/H digital terrestrial television transmission and IEEE network standards such as 802.11 (“WiFi”), 802.16 (“WiMAX”), 802.20 (proposed PHY). Such transceivers have large arithmetic processing requirements which can become prohibitive if implemented in software on a DSP processor.

The present invention in one or more implementations may be implemented as part of a data system, an application operable with a data system, a remote software application for use with a data storage system or device, and in other arrangements.

Although the present invention has been described in accordance with the embodiments shown, one of ordinary skill in the art will readily recognize that there could be variations to the embodiments and those variations would be within the spirit and scope of the present invention. Accordingly, many modifications may be made by one of ordinary skill in the art without departing from the spirit and scope of the appended claims.

Various implementations of a radar detection methodologies and systems have been described. Nevertheless, one of ordinary skill in the art will readily recognize that various modifications may be made to the implementations, and any variations would be within the spirit and scope of the present invention. For example, the above-described process flow is described with reference to a particular ordering of process actions. However, the ordering of many of the described process actions may be changed without affecting the scope or operation of the invention. Accordingly, many modifications may be made by one of ordinary skill in the art without departing from the spirit and scope of the following claims.

What is claimed is:

1. A configurable radar detection system comprising:
one or more radar detector modules each module capable of detecting radar signals of radar types different one another,
a detection and analysis module to determine radar presence from one or more detected radar signals of one or more radar detector modules,
an automatic gain controller for controlling one or more detection parameters of one or more radar detector modules, and,
a report signal for reporting detected radar signals.

2. The system of claim 1 wherein the detection and analysis module further comprises a pattern recognition process for determining a presence of absence of radar from detected radar signals.

3. The system of claim 2, wherein the pattern recognition process is validated by a validation process as against one or more known radar signal templates.

4. The system of claim 3, wherein the validation process comprises choosing M events that result in M-1 periods, defining p minimum periods, verifying p is a valid radar period, checking time differences are multiples of p for all other time differences, checking relative widths of width w of p, and rendering valid M events to be valid with period p and width w if all above conditions are true.

5. The system of claim 2, further comprising a wi-fi device.

6. The system of claim 5, wherein the wi-fi device is a wi-fi access point capable of communication with one or more client devices and the radar detector modules are individually programmable.

7. The system of claim 6, wherein the access point further comprises a baseband and a medium access control, wherein the baseband provides filtering on a received radar signal to remove non-radar signal energy, and the medium access control compares a received radar signal with one or more known radar patterns.

8. The system of claim 5 wherein the report signal is a channel control message sent by the device to one or more client devices of the device.

9. The system of claim 7, wherein the report signal is a channel control message sent by the access point to one or more client devices.

10. The system of claim 9, wherein the control message includes instructions to one or more client devices for one or more of change operating channels for communication, cease communications on present channel, identification of one or more radar signal transmissions, delayed transmission information, or future communication channel frequency.

11. The system of claim 10, wherein the access point is operable in an unlicensed radio band range.

12. The system of claim 10, wherein the filtering is a two-stage auto-correlation filter.

13. The system of claim 12, wherein the filter comprises:
$$y ( k ) = {\sum }_{j = 0} x ( k - j ) x * ( k - j - T ) ,$$
where x(k) is input, y(k) is output, N is length of autocorrelation average, T, which is delay.

14. The system of claim 13 including an OFDM transceiver and has a plurality of radar detection modules.

15. A system for detecting radar signals on an unlicensed radio band, comprising a radio frequency to baseband converter for converting received radar signals, a baseband module for filtering and logging received radar signals, a medium access control module for identifying received radar signals in comparison with one or more known radar signal types, and reporting across a communication network information regarding received radar signals.

16. The system of claim 15, wherein the medium access control is comprised of program instructions and the communication network comprises one or more client devices.

17. The system of claim 15, wherein the system determines when a received radar signal traverses a HIGH state or a LOW state and further determines a period count, a period length, and a pulse width count.

18. The system of claim 17 wherein a detection log logs received radar signals and a filtering comprises toggling between a LOW state and a HIGH state for periodic detection and alternating between a LOW state and a HIGH state for pulse width radar detection.

19. The system of claim 18 further comprising a long-pulse detector module and filtering performed by an auto-correlation filter.

20. The system of claim 18 further wherein a report is generated reporting status of received radar signals to one or more client devices of the communication network.

21. The system of claim 20, wherein the received radar signals are validated against known radar signal types by the steps of: choosing M events that result in M-1 periods, defining p minimum periods, verifying p is a valid radar period, checking time differences are multiples of p for all other time differences, checking relative widths of width w of p, and rendering valid M events to be valid with period p and width w if all above conditions are true.

22. A wireless access device on a communication network capable of detecting radar signals and automatically notifying client devices in communication with the device to one or more of changing communication channel, delaying communication and ceasing communication, having an instantiable computer program product for detecting and avoiding one or more radar signals and communicating information regarding detected radar signals stored on a data storage device accessible by the data system, comprising a computer-readable storage medium having computer-readable program code portions stored therein, the computer-readable program code portions including: a first executable portion having instructions being capable of:
receiving one or more radar signals,
filtering received one or more radar signals,
identifying a status of the filtered one or more radar signals as being false or true,
notifying one or more client devices on the communication network as to a status of the identified one or more radar signals,
and automatically communicating with one or more client devices.

23. The system of claim 22, wherein the automatically communicating with one or more client devices includes instructions of one or more of changing operating channels for communication, ceasing communications on present channel, identifying one or more radar signal transmissions, providing delayed transmission information, or directing future communication channel frequency.

24. The system of claim 22, wherein certain of the detected radar signals are validated against known radar signal types by the steps of: choosing M events that result in M-1 periods, defining p minimum periods, verifying p is a valid radar period, checking time differences are multiples of p for all other time differences, checking relative widths of width w of p, and rendering valid M events to be valid with period p and width w if all above conditions are true.

25. The system of claim 22, further comprising a baseband and a medium access control, wherein the baseband provides filtering on a received radar signal to remove non-radar signal energy, and the medium access control compares a received radar signal with one or more known radar patterns.
